(19) United States
(12) Patent Application Publication
(10) Pub. No.: US 2026/0211877 A1
(43) Pub. Date: Jul. 23, 2026

(54) DATABASE QUERY TRANSLATION AND TRAINING DATA GENERATION

(71) Applicant: Adobe Inc., San Jose, CA (US)

(72) Inventors: Fei Wu, Seattle, WA (US); Yunyao Li, San Jose, CA (US); Yuan Tian, West Lafayette, IN (US); Tung Thanh Mai, San Jose, CA (US); Siddhartha Sahai, Bellevue, WA (US); Kun Qian, Sammamish, WA (US); Daniel Joonseok Lee, San Jose, CA (US)

(73) Assignee: Adobe Inc., San Jose, CA (US)

(21) Appl. No.: 19/034,364

(22) Filed: Jan. 22, 2025

(51) Int. Cl. G06F 16/2452; G06F 16/242

(52) U.S. Cl. CPC G06F 16/24522; G06F 16/2428

(57) ABSTRACT

Database query translation and training data generation techniques are described. In one or more example, by forming a source database and database query based on a database schema, a query annotation system establishes a foundation for accurate query processing. A natural language query is generated from the database query using machine-learning models, which is then output for editing in a user interface. By generating the database query from the database schema itself and the natural language query from the database query, the query annotation system is configured to readily adapt to database changes.

### BACKGROUND

Natural language interfaces have been employed by database systems to broaden user access to a database. Access to conventional database systems, for instance, initially involved specialized knowledge regarding what database queries are supported, an overall database schema employed to store records, and so forth. As such, these initial conventional techniques were limited to sophisticated users having significant amounts of experience that is typically gained over a significant amount of time.

Consequently, further conventional techniques were developed in an attempt to broaden this user access by supporting natural language functionalities. However, these further conventional techniques encounter numerous technical challenges that hinder the accuracy and performance of the database access, including an inability of conventional techniques to adapt to diverse database schemas and domain-specific terminology that in real-world scenarios typically evolves over time.

### SUMMARY

Database query translation and training data generation techniques are described. In one or more example, by forming a source database and database query based on a database schema, a query annotation system establishes a foundation for accurate query processing. A natural language query is generated from the database query using machine-learning models, which is then output for editing in a user interface which supports intuitive user interaction with complex database structures. This ability to form an edited natural language query based on user input via an interface allows for refinement and customization of training data that is then usable to train a machine-learning model to perform query translation. By generating the database query from the database schema itself and the natural language query from the database query, the query annotation system is configured to readily adapt to database changes. This approach may enhance query accuracy, reduce involvement of specialized database knowledge by a user, and improve overall efficiency in database interactions.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is an illustration of a digital medium environment in an example implementation that is operable to employ database query translation and training data generation techniques described herein.

FIG. 2 depicts a system in an example implementation showing operation of the query annotation system of FIG. 1 in greater detail as generating training data based on a database schema.

FIG. 3 depicts a system showing operation of the database system in greater detail as training the machine-learning model based on the training data.

FIG. 4 depicts an example implementation of a user interface as output by the query annotation system of FIG. 2 that supports generation of a database schema.

FIG. 5 depicts an example implementation of a user interface as output by the query annotation system of FIG. 2 that supports database population.

FIG. 6 depicts an example implementation of a user interface as output by the query annotation system of FIG. 2 that supports data generation, error detection, and control.

FIG. 7 depicts a user interface in an example implementation as generated by the query annotation system in support of post-synthesis analysis and automated annotation.

FIG. 8 depicts a user interface in an example implementation as generated by the query annotation system in support of dataset diversity analysis.

FIG. 9 depicts a user interface in an example implementation as generated by the query annotation system in support of database query synthesis.

FIG. 10 depicts a user interface in an example implementation as generated by the query annotation system in support of database query decomposition.

FIG. 11 depicts a user interface in an example implementation as generated by the query annotation system in support of natural language query generation.

FIG. 12 depicts a user interface in an example implementation as generated by the query annotation system in support of alignment generation techniques based on visual linking of query elements with steps of a step-by-step explanation.

FIG. 13 depicts a user interface in an example implementation as generated by the query annotation system in support of alignment checking techniques based on visual linking of query elements with steps of a step-by-step explanation.

FIG. 14 is a flow diagram depicting an algorithm as a step-by-step procedure in an example implementation of operations performable for accomplishing a result of generating training data and training a machine-learning model based on the training data to translate a natural language query to a database query.

FIG. 15 depicts a system in an example implementation showing training of the machine-learning model of FIG. 1 in greater detail using the training data as generated in FIG. 2.

FIG. 16 illustrates an example system including various components of an example device that can be implemented as any type of computing device as described and/or utilize with reference to FIGS. 1-15 to implement embodiments of the techniques described herein.

### DETAILED DESCRIPTION

### Overview

Complexity of databases and database schemas used to control how records are stored and accessed from the databases continually increases in response to increases in the types and amounts of data stored in the databases. Consequently, conventional database access is often limited to sophisticated users having significant amounts of experience that is typically gained over a significant amount of time in order to gain specialized knowledge.

To address these technical challenges, conventional techniques have been expanded to implement natural language interfaces. These techniques typically involve translating natural language questions into formal database query languages that are understood by a database system. However, conventional techniques often fail in this translation due to a variety of technical challenges, including an inability to adapt to diverse database schemas and domain-specific terminology across different contexts. Because of this, translation performance of these conventional techniques often deteriorates substantially in real-world scenarios when applied to new domains or updated database structures.

Accordingly, database query translation and training techniques are described. These techniques support training data generation usable to train a machine-learning model to translate a natural language query into a database query, e.g., a structured query language (SQL) query. In this way, access to the database system is expanded to users having generalized knowledge.

To do so, a database system outputs a visual representation in a user interface that supports edits and generation of a database schema. The database schema is a formal structure that defines the organization of data within a database system. The database schema defines a logical configuration of a relational database, including tables, columns, data types, indexes, and the relationships between these entities. The schema serves as a blueprint for constructing and managing the database, ensuring data integrity, consistency, and accessibility.

A database schema, for instance, defines tables as fundamental units of data storage, each table having of rows and columns. Each row represents a unique record, while each column represents a specific attribute of the data. Columns are defined within the tables and specify a type of data that can be stored (e.g., integer, varchar, date) and respective constraints, e.g., primary key, foreign key, not null, and so forth. Data types define the nature of the data that are storable in each column, such as integers, strings, dates, and binary data. Indexes are structures that support retrieval operations on a database table. Constraints include rules enforced on data columns to ensure data integrity and consistency. Examples of constraints include primary keys, foreign keys, unique constraints, and check constraints. Relationships define logical connections between tables, typically defined through foreign keys, which establish referential integrity between related data. The schema is definable in a variety of ways, examples of which include use of a data definition language (DDL), such as a structured query language (SQL), which provides commands for creating, altering, and deleting schema objects.

Once the database schema is received in a desired form for processing, the database system populates a source database and database queries in one or more examples. The database queries are generated from a database schema and/or the source database that is populated based on the database schema. The database system, for instance, is configurable to output an option in the user interface to specify a number of records to be generated for the source database. The records are then generated, automatically and without user intervention, using statistical or rule-based techniques, one or more machine-learning models (e.g., an LLM), and so forth to populate the source database.

The database queries may also be generated using the one or more machine-learning models (e.g., an LLM) based on the database schema and/or the source database. Once generated, in one or more examples, the database queries are output in the user interface, which supports edits to the database queries.

The database queries are then used as a basis by the database system to generate natural language queries using the one or more machine-learning models. In one or more examples, the natural language queries are output with a corresponding step-by-step explanation generated by the one or more machine-learning models indicating how the natural language queries are generated.

As part of this, the step-by-step explanation may be visually linked in the user interface with corresponding elements of the natural language query, e.g., via color coding, arrows, display styles, and so forth. The step-by-step explanation may also be visually linked with corresponding elements of the database query. The visual linking between steps and corresponding elements of the queries may be used to identify errors or other discrepancies, e.g., missing steps, elements that are not addressed, and so forth.

Subsequent edits may then be received to make corrections, e.g., by “hovering” over elements and outputting a visual linking of those elements with corresponding elements of the other queries. In this way, the user interface supports error detection and repair through annotations received via the user interface to inject missing steps, delete redundant text, and so forth. Use of the subsequent edits may also be used to address potential inaccuracies, lack of diversity in generated queries, and difficulties in maintaining consistency across large datasets.

The natural language queries, as generated from the database queries and annotated through interaction with the user interface as described above support a variety of functionalities. The natural language queries, for instance, are usable as training data along with the database queries to train a machine-learning model to translate a natural language query into a database query, e.g., as positive training samples. As a result, the techniques described herein are adaptable to learn directly from a database schema, which supports an ability to address continual changes to the database schema. This is not possible in conventional techniques that instead focus on a reverse process to manual generation in which the database query is generated from the natural language query. Further discussion of these and other examples is included in the following section and shown in corresponding figures.

### Term Examples

A “machine-learning model” refers to a computer representation that can be tuned (e.g., trained and retrained) based on inputs to approximate unknown functions. In particular, the term machine-learning model can include a model that utilizes algorithms to learn from, and make predictions on, known data by analyzing training data to learn and relearn to generate outputs that reflect patterns and attributes of the training data. Examples of machine-learning models include neural networks, convolutional neural networks (CNNs), long short-term memory (LSTM) neural networks, decision trees, and so forth.

A “large language model” (LLM) is a type of machine-learning model that is designed to understand, generate, and interact with human language inputs at a large scale. These machine-learning models are trained on vast amounts of text data using deep learning techniques (e.g., neural networks) to learn patterns, nuances, and the structure of language. The use of the term “large” refers to both the size of the training data and also to the complexity and scale of the neural networks, which may include billions or even trillions of parameters.

Large language models are configurable to perform a wide range of language-related tasks without being explicitly programmed for each one. Examples of these tasks include text generation, translation, summarization, question answering, sentiment analysis, and natural language processing. To train a large language model, the underlying machine-learning model is provided with training data that includes examples of text to train and retrain the model to predict a next word in a sequence. Over time, the model, once trained, is configured to generate text that is coherent and contextually relevant, is configurable to mimic a style and content of the training data, and so forth. In this way, large language models provide a foundational tool in artificial intelligence for understanding and generating human language, powering a wide range of applications from conversational agents to content creation tools.

A “database schema” defines tables as fundamental units of data storage, each table having of rows and columns. Each row represents a unique record, while each column represents a specific attribute of the data. The database schema is definable in a variety of ways, examples of which include use of a data definition language (DDL), such as a structured query language (SQL), which provides commands for creating, altering, and deleting schema objects.

“Columns” are defined within the tables and specify a type of data that can be stored (e.g., integer, varchar, date) and respective constraints, e.g., primary key, foreign key, not null, and so forth.

“Data types” define the nature of the data that are storable in each column, such as integers, strings, dates, and binary data.

“Indexes” are structures that support retrieval operations on a database table.

“Constraints” include rules enforced on data columns to ensure data integrity and consistency. Examples of constraints include primary keys, foreign keys, unique constraints, and check constraints.

“Relationships” define logical connections between tables, typically defined through foreign keys, which establish referential integrity between related data.

In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Example Database Query Training Environment

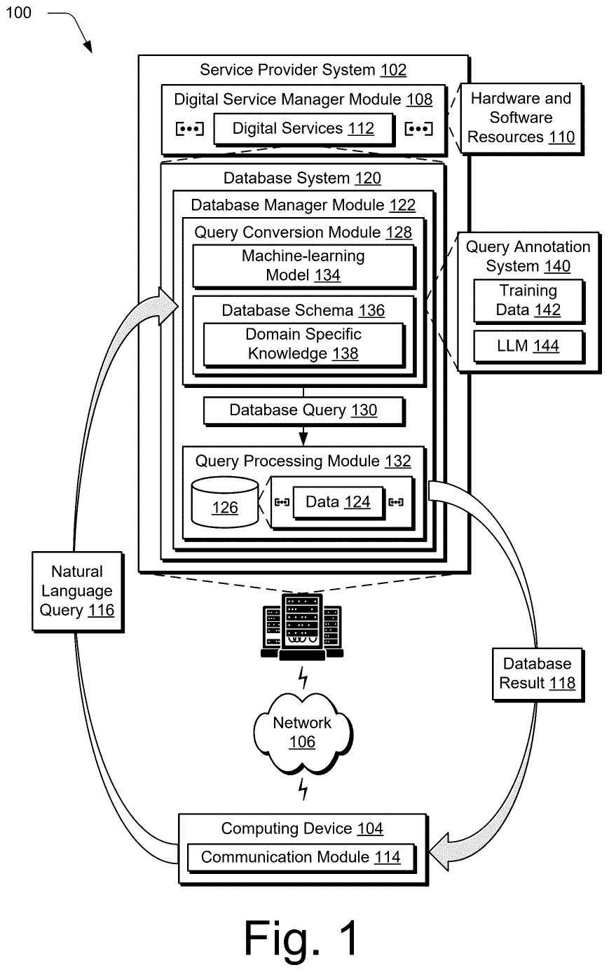

FIG. 1 is an illustration of a digital medium environment 100 in an example implementation that is operable to employ database query translation and training data generation techniques described herein. The illustrated environment 100 includes a service provider system 102 and a computing device 104 that are communicatively coupled, one to another, via a network 106. Computing devices are configurable in a variety of ways.

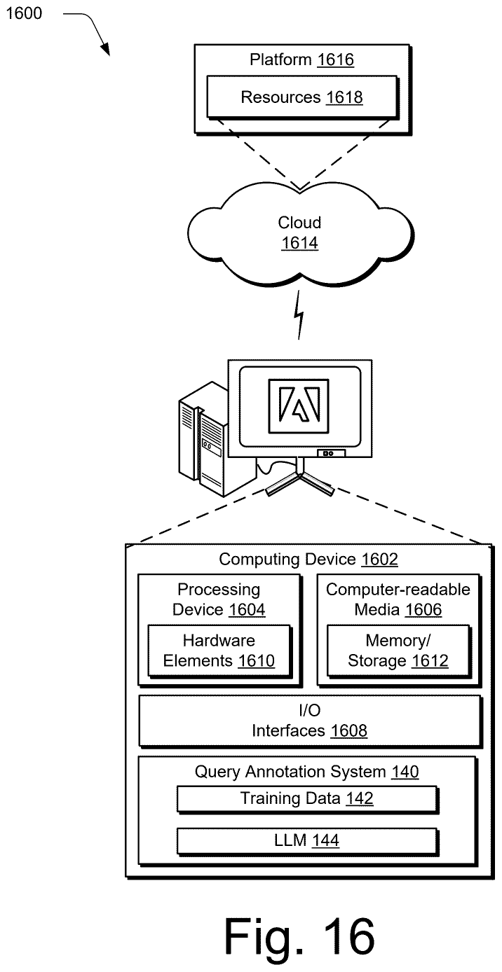

A computing device, for instance, is configurable as a desktop computer, a laptop computer, a mobile device (e.g., assuming a handheld configuration such as a tablet or mobile phone), and so forth. Thus, a computing device ranges from full resource devices with substantial memory and processor resources (e.g., personal computers, game consoles) to a low-resource device with limited memory and/or processing resources (e.g., mobile devices). Additionally, although a single computing device is shown and described in instances in the following discussion, a computing device is also representative of a plurality of different devices, such as multiple servers utilized by a business to perform operations “over the cloud” for the service provider system 102 and as further described in relation to FIG. 16.

The service provider system 102 includes a digital service manager module 108 that is implemented using hardware and software resources 110 (e.g., a processing device and computer-readable storage medium) in support one or more digital services 112. Digital services 112 are made available, remotely, via the network 106 to computing devices, e.g., computing device 104.

Digital services 112 are scalable through implementation by the hardware and software resources 110 and support a variety of functionalities, including accessibility, verification, real-time processing, analytics, load balancing, and so forth. Examples of digital services include a social media service, streaming service, digital content repository service, content collaboration service, and so on. Accordingly, in the illustrated example, a communication module 114 (e.g., browser, network-enabled application, and so on) is utilized by the computing device 104 to access the one or more digital services 112 via the network 106. A result of processing using the digital services 112 is then returned to the computing device 104 via the network 106.

In the illustrated example, the communication module 114 outputs a natural language query 116 that is processed to generate a database result 118 by a database system 120 implemented by the digital services 112. Other examples are also contemplated in which the database system 120 is implemented locally at the computing device 104. The database system 120 includes a database manager module 122 that is configured to manage access to data 124 (e.g., records) maintained in a database 126.

To do so, the database manager module 122 is configured to expand accessibility to the data 124 as part of the database 126 through use of a query conversion module 128 without involving specialized knowledge as was involved with conventional techniques. The query conversion module 128 is configured to translate the natural language query 116 into a database query 130 (e.g., in compliance with a data definition language (DDL)) using a machine-learning model 134. The machine-learning model 134 is trained in this example using training data based on a database schema 136 which may include domain specific knowledge 138.

In conventional techniques, training data used to train a machine-learning model for query translation is manually created. In real world scenarios, however, the machine learning models are tasked with adapting to continual changes in database schemas, which introduces several technical challenges. As such, this manual approach is time-consuming, labor-intensive, and computationally resource intensive due to tasking domain experts to generate diverse and representative examples in response to each schema update. Further, this manual approach struggles to keep pace with frequent database schema changes, leading to a constant lag between database schema updates and corresponding machine-learning model adaptations and training. The manual approach is also prone to human biases and inconsistencies, potentially resulting in datasets that do not adequately cover a full range of possible queries or fail to capture subtle schema nuances.

Furthermore, as complexity of schemas increases, the difficulty of manually crafting accurate and diverse query-result pairs also increases. This complexity makes it technically challenging to maintain dataset quality and comprehensiveness of training data that is used to train the machine-learning models. Because of this, machine-learning models may be trained that perform well on common query patterns but fail on edge cases or newly introduced schema elements of an updated database schema with little to no insight into whether the failures are even encountered. The scalability of manual data creation is also limited, making it impractical for large-scale, rapidly evolving database systems to employ continuous model in order to maintain performance and accuracy.

Accordingly, to address these and other technical challenges the query conversion module 128 employs a query annotation system 140 that is configured to improve generation and accuracy of training data 142 usable to train the machine-learning model 134 to perform query translation. To do so, the query annotation system 140 employs one or more machine-learning models, an illustrated example of which includes an LLM 144.

The query annotation system 140 supports several technical advantages in generating training data 142 for natural language to database query translation models. By automating aspects of the data generation process, the query annotation system 140 significantly reduces an amount of time and labor involved in creating diverse and representative datasets for use as training data 142. The query annotation system 140 also supports an ability to dynamically adapt to changes to the database schema 136 which allows for rapid generation of new training examples that reflect the current database structure. In this way, the query annotation system 140 counteracts lag typically associated with manual training data creation as previously described, which improves an ability to timely train the machine-learning model 134 for deployment.

The query annotation system 140, for instance, may employ rule-based database query generation, combined with an LLM-powered natural language translation, as a way to ensure wide query coverage while maintaining consistency with the database schema 136. The query annotation system 140 is configurable to employ a variety of functionalities, examples of which include interactive error detection and repair mechanisms, a step-by-step analysis feature, and so forth to enable efficient human validation and refinement of the training data 124. In this way, the query annotation system 140 strikes a balance between automation and human expertise. The query annotation system 140 also helps mitigate against biases and inconsistencies often present in manually created datasets. Furthermore, the query annotation system 140 is configured to leverage dataset composition analysis tools for fine-grained control over the diversity and distribution of the generated training data 142, ensuring comprehensive coverage of both common and edge cases. These features collectively enable the creation of high-quality, schema-specific datasets at scale, facilitating continuous adaptation of the machine-learning model 134 to evolving database structures of the database schema 136, which is not possible in conventional techniques.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Example Training Data Generation for Query Translation

The following discussion describes training data generation techniques usable for training a machine-learning model to translate a natural language query into a database query that are implementable utilizing the described systems and devices. Aspects of each of the procedures are implemented in hardware, firmware, software, or a combination thereof. The procedures are shown as a set of blocks that specify operations performable by hardware and are not necessarily limited to the orders shown for performing the operations by the respective blocks. Blocks of the procedures, for instance, specify operations programmable by hardware (e.g., processor, microprocessor, controller, firmware) as instructions thereby creating a special purpose machine for carrying out an algorithm as illustrated by the flow diagram. As a result, the instructions are storable on a computer-readable storage medium that causes the hardware to perform the algorithm.

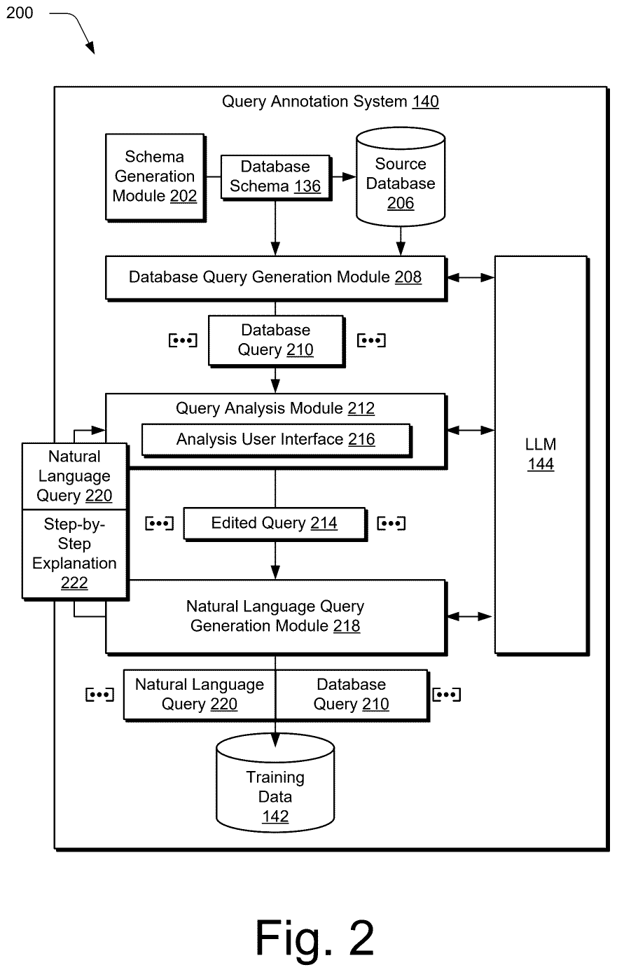

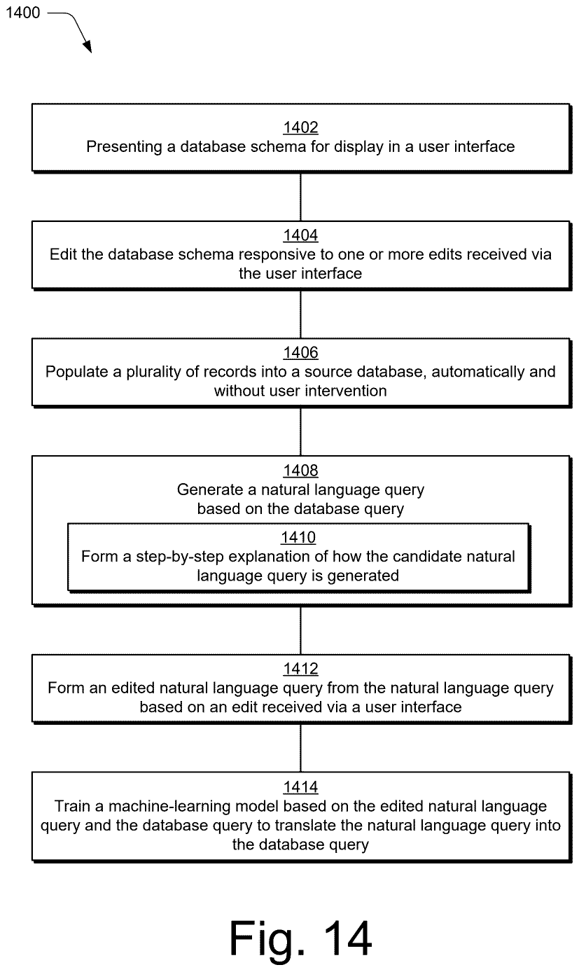

FIG. 2 depicts a system 200 in an example implementation showing operation of the query annotation system 140 of FIG. 1 in greater detail as generating training data 142 based on a database schema 136. FIG. 14 is a flow diagram depicting an algorithm 1400 as a step-by-step procedure in an example implementation of operations performable for accomplishing a result of generating training data and training a machine-learning model based on the training data to translate a natural language query to a database query.

To begin in this example, a schema generation module 202 is employed by the query annotation system 140 to present a database schema 136 for display in a user interface (block 1402). The user interface, as output by the schema generation module 202 supports an edit the database schema 136 responsive to one or more edits received via the user interface (block 1404).

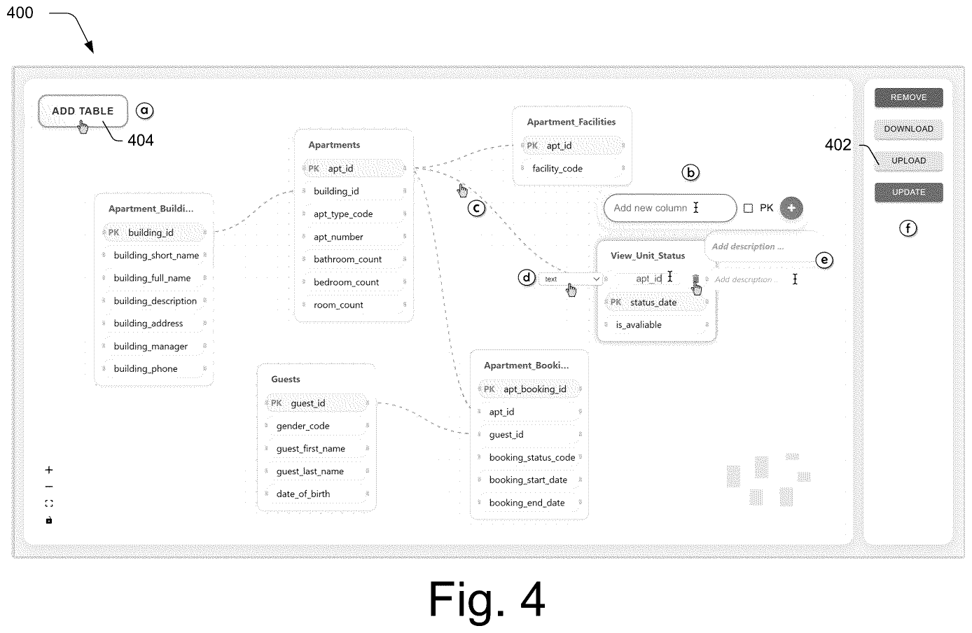

FIG. 4 depicts an example implementation of a user interface 400 as output by the query annotation system 140 of FIG. 2 that supports generation of a database schema 136. The query annotation system 140 facilitates user comprehension of complex database schemas through an interactive graph visualization in the user interface 400 in this example. Users, for instance, can upload schemas by dragging files onto the canvas or using an upload button 402. The query annotation system 140 represents tables in the user interface 400 as rectangular boxes with columns listed as rows inside. Primary keys are visually indicated and marked “PK”. Reference relationships between tables are shown as dashed lines with flow animation to indicate direction. In this way, users can inspect details by hovering over columns and tables to view data types or descriptions. The user interface 400 also allows dragging tables, zooming, and panning for easy navigation.

The schema visualization output by the query annotation system 140 is fully editable. Users, for instance, can add new tables via an add table button 404, and hover over tables, add columns, designate primary keys, and so forth. The query annotation system 140 also supports inputs to specify data types for columns and establish foreign key relationships by directly linking columns between tables. Removal of columns, for example, may be facilitated by a trash icon that appears on hover, while tables and reference links may be deleted using a delete key of a keyboard. This interactive editing capability allows users to update the database schema 136 as desired.

Query annotation system 140, in one or more implementations, encourages clear documentation of database entities, which often use abbreviations in practice. The query annotation system 140, for instance, prompts users to add descriptions to tables and columns having abbreviations before annotation, enhancing an ability of the LLM 144 to interpret the database schema 136 and provide accurate edit suggestions in subsequent steps. For improved schema management, the query annotation system 140 is configurable to offer options to remove the entire database schema 136, as well as download or upload schemas as JavaScript Object Notation (JSON) files. These features collectively enable efficient comprehension and manipulation of complex database schemas within the annotation process.

Returning again to FIG. 2, the database schema 136, once generated and/or received by the query annotation system 140 from another source (e.g., a storage device) is then utilized to populate a plurality of records into a source database 204, automatically and without user intervention (block 1406). The query annotation system 140 is configurable, for instance, to address challenge of referencing specific values in database queries during annotation by enabling users to instantly populate the source database 204 with diverse synthetic values. This populated source database 204 supports a variety of functions including an ability to provide a source for value retrieval and support execution of annotated database queries to validate correctness.

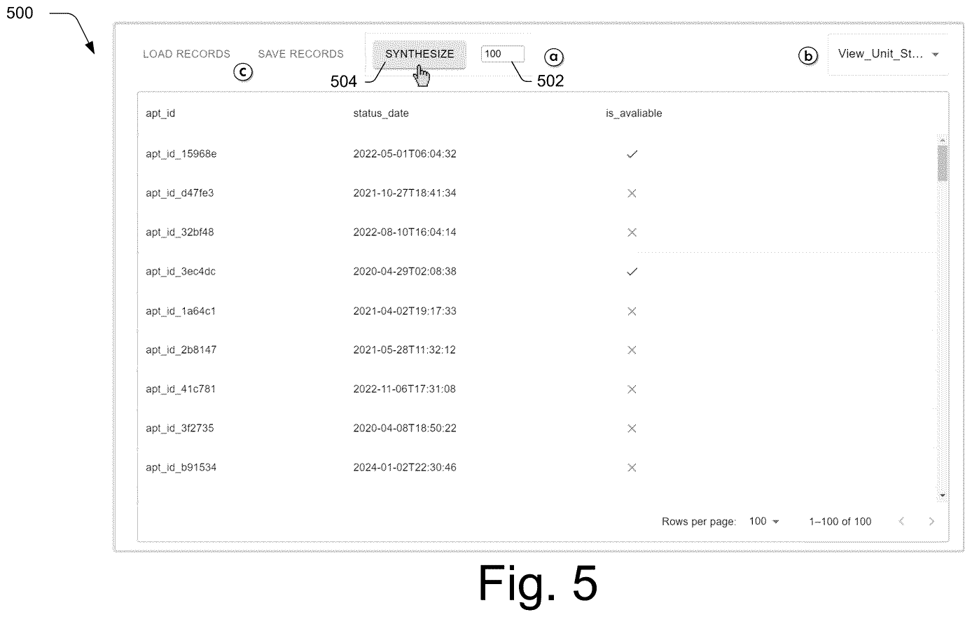

FIG. 5 depicts an example implementation of a user interface 500 as output by the query annotation system 140 of FIG. 2 that supports database population. The user interface 500 is configured to support an input to specify a desired number 502 of records and initiate synthesis through selection of an option 504, e.g., with a “single click.”

The query annotation system 140 is configurable to employ rule-based techniques to randomly generate records based on supported data types, e.g., “text,” “Boolean,” “int,” “timestamp,” “float,” “double,” “decimal,” and “enum.” For example, “apt_id” as a text field is generated by appending a random UUID to the “apt_id” prefix, while “status_date” as a timestamp field generates values such as “2022-05-01T06:04:32.”

When generating random values, the query annotation system 140 is configurable to identify primary and foreign key relationships as constraints. For foreign keys, for instance, instead of generating new values, the query annotation system 140 retrieves existing values from the referenced column. The probability of generating repetitive records can be adjusted through use of a configuration file, e.g., with a default probability of 0.3. The user interface 500 also supports navigation between different tables via a drop-down menu and supports storage of current database records, upload of existing database records (e.g., in a JSON format), and so forth.

Although the populated synthetic values may not reflect real-world distributions, this does not affect the annotation process in these examples. Rather, these values may serve as placeholders for annotation and to verify that the annotated database queries are executable on the database. In database queries, values are used for referencing purposes and do not alter the query's underlying structure or meaning. Machine-learning models, in one or more examples, are not directly trained on these values but rather these values may assist in generating database queries that are then to be used to generate natural language queries.

In this way, the query annotation system 140 differs from conventional techniques by creating executable database queries associated with execution results, allowing a better understanding of query behaviors. As a result, the query annotation system 140 ensures that the generated database queries are valid and are executable against the populated database 204, thereby enhancing overall quality and practicality of the annotation and editing process, which is not possible in conventional techniques.

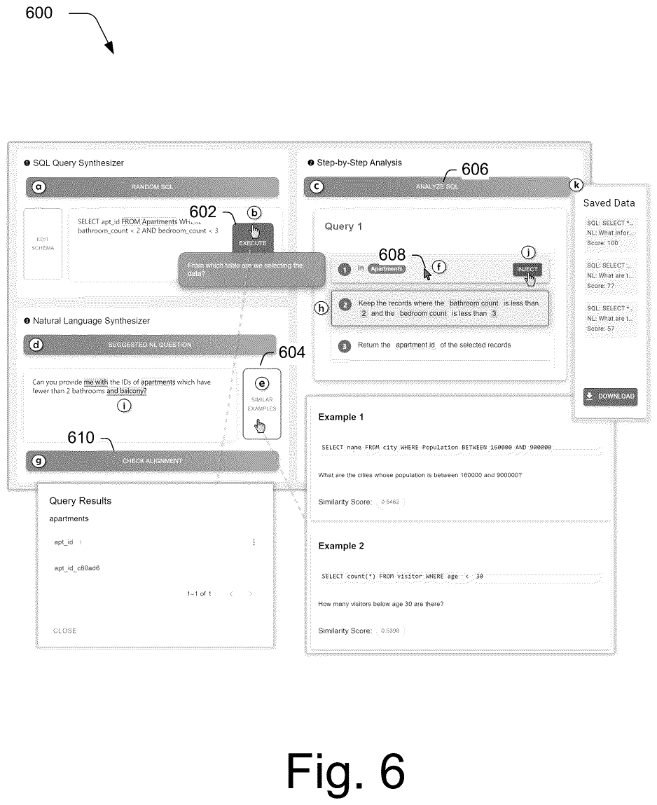

Returning again to FIG. 2, the database schema 136, once generated and/or received by the query annotation system 140 from another source (e.g., a storage device) is then utilized by a database query generation module 208 to generate a database query 210. In this example, the database query generation module 208 is configured to generate unbiased database queries (e.g., for “new” and/or complex database schemas) by offering a suggested database query that is randomly sampled based on database query grammar using the populated source database 206. FIG. 6 depicts an example implementation of a user interface 600 as output by the query annotation system 140 of FIG. 2 that supports data generation, error detection, and control.

The database query generation module 208, for instance, is configurable to generate a database query 210 based on the database schema 136, e.g., either directly on the database schema 136, indirectly through use of the populated source database 206, and so forth. The database query 210, once generated, is then output to a query analysis module 212 that is configured to support output of an analysis user interface 216 that supports user edits to a query, which causes output of an edited query 214, e.g., which is an edited form of the database query 210 in this example.

To do so in one or more examples, the database query generation module 208 employs a pre-defined probabilistic context-free grammar (PCFG) configured for database queries, which is modifiable via a configuration file. Although the grammar supports manual configuration, the database query generation module 208 is also configurable to automatically learn keyword probability distributions, e.g., from an imported dataset. The user interface 600 is then output by the database query generation module 208 in support of direct edits to the database query 210 as desired, to check an execution result of the query, and so forth. In this way, the PCFG-based approach of query annotation system 140 offers improved control over query diversity and correctness and helps to mitigate against issues such as bias or hallucination. The user interface 600 as illustrated in FIG. 6 is configured to display the natural language query concurrently with the database query. Other examples are also contemplated, including use of the LLM 144 as illustrated in FIG. 2.

Return will now be made again to FIG. 2, in which the database query 210, once generated by the database query generation module 208 based on the database schema 136, is then utilized by a natural language query generation module 218 to generate a natural language query 220 (block 1408). The database query generation module 208, for instance, is configurable to employ the LLM 144 to generate the natural language query 220. The LLM 144 is also configurable to form a step-by-step explanation of how the natural language query 220 is generated (block 1410). The natural language query 220 may then be returned to the query analysis module 212 for analysis and editing through an iterative workflow, e.g., to form the edited query 214 as an edited natural language query from the natural language query 220 based on an edit received via a user interface (block 1412).

The natural language query generation module 218, for instance, is configurable to generate the natural language query 220 by translating the database query 210 using the LLM 144. In one or more implementations, the natural language query generation module 218 employs in-context learning to increase translation accuracy of database queries to natural language queries. The natural language query generation module 218, for example, retrieves similar examples from a text-to-database query data pool, which contains previously annotated data, real-world text-to-database query pairs, and so forth. The natural language query generation module 218 is configurable to calculate similarity scores between database queries using abstract syntax trees and selecting a predefined number, e.g., the top five examples with scores above 0.5.

Using these retrieved examples, the natural language query generation module 218 performs few-shot learning to translate the database query 210 into a natural language query 220. This approach may be configured to leverage a context provided by similar, previously annotated queries to improve the accuracy and relevance of the generated natural language query 220.

An option 604 is included in the user interface of FIG. 6 to access and review these similar examples. These real-world examples support a variety of functionalities, including an ability to assist a machine-learning model in generating accurate translations and to better assess the quality of the LLM-suggested natural language query 220. Through communication with the query analysis module 212, the natural language query generation module 218 also supports edits to the natural language query 220 thereby supporting adjustments to improve accuracy or clarity.

The natural language query generation module 218, as previously described, is also configurable to prompt the LLM 144 to provide a step-by-step explanation 222 of how the natural language query 220 is generated based on the database query 210. The step-by-step explanation 222 may also be generated by the LLM 144 to describe a generation process of the database query 210 in one or more examples. The step-by-step explanation 222, for instance, is configurable to enhance user comprehension of database queries and based on this detect potential errors by providing step-by-step explanations 606 in natural language as shown in the user interface 600 of FIG. 6.

The natural language query generation module 218, for instance, parses the database query 210 and maps the database query 210 to natural language templates through a database query grammar. To improve fluency and handle scenarios that are not covered by the original grammar, natural language query generation module 218 enhances this approach using the LLM 144.

If this explanation generation approach fails, the natural language query generation module 218 prompts the LLM 144 to generate the step-by-step explanation 222 using few-shot learning from rule-based explanation examples. The generated explanations are then paraphrased based on the database schema 136, e.g., to enhance fluidity and naturalness of the text included in the step-by-step explanation 222. To further improve readability, the natural language query generation module 218 is also configured to identify and highlight columns, tables, and values as visual indications to show correspondence between elements of the database query 210 and/or the natural language query 220 with steps of the step-by-step explanation 222.

For each step, query annotation system 140 renders a corresponding sub-question, e.g., as shown in the user interface 600 on the left a cursor 608 “hovers” over the step. This feature is achieved by synthesizing a simpler database query that solely includes the database query element associated with that step, which is then translated to a natural language query by the LLM 144. This approach provides a granular explanation of each element of the database query 210 and its corresponding element of the natural language query 220.

The query annotation system 140 (e.g., through use of the query analysis module 212 and/or the natural language query generation module 218) creates a visual link (e.g., as a triple-linkage) between the database query 210, natural language query 220, and step-by-step explanation 222, e.g., in response to selection of a check alignment button 610 in the user interface 600 of FIG. 6. The step-by-step explanation 222 acts as a bridge, with a one-to-one mapping between elements of the database query 210 and steps of the step-by-step explanation 222 due to its grammar-based nature.

The query annotation system 140, for instance, uses the LLM 144 to align the step-by-step explanation 222 with the natural language query 220, creating a one-to-many mapping by identifying related substrings in the natural language query 220 for each explanation step. When a cursor is positioned to “hover” over an explanation step, for instance, the query annotation system 140 highlights the corresponding element of the database query 210 and related question substrings, enhancing user understanding and aiding in error detection.

In this way, the query annotation system 140 supports an interactive error detection and correction approach by aligning the natural language query 220 with the database query 210 through the step-by-step explanation 222. Although there is a high likelihood of correctness of database queries sampled using PCFG, the natural language query 220 generated by an LLM 144 can introduce errors due to hallucination.

To address this, the query annotation system 140 is configurable to identify a variety of types of misalignment. In a first example, if an element (e.g., substring) in the natural language query 220 fails to map to a step in the step-by-step explanation 222, the query annotation system 140 provides a visual indication associated with that element suggesting that the element may be irrelevant to the database query 210.

In a second example, if a certain step in the step-by-step explanation 222 does not map to an element in the natural language query 220, query annotation system 140 provides a visual indication associated with that step indicating that information mentioned in this step may be missing from the natural language query 220. This visual feedback system allows users to quickly identify and address potential discrepancies between the database query 210 and its corresponding natural language query 220, improving the overall quality and accuracy of the query annotation process.

Consider a scenario involving Bob, a data scientist tasked with supporting a database system 120 at a rapidly growing tech company has been tasked with creating a high-quality text-to-database dataset for training and evaluating a new natural language interface for the company's recently updated database system. The data scientist faces several challenges that make this task particularly daunting. First, the company has just completed a major update to its database schema, introducing new tables and relationships to accommodate expanding business needs. This update has rendered existing datasets obsolete, as the datasets no longer match the current schema structure. Consequently, there is no existing evaluation text-to-database dataset that aligns with the updated schema, making it difficult to accurately assess the performance of the natural language interface.

The high complexity of the database schema 136, with numerous tables and intricate relationships, adds to the challenge. Manually updating existing datasets to reflect these changes is impractical. Manual generation as previously described is time-consuming and challenging, especially given the intricacies of the new database schema 136. Recognizing these challenges, the query annotation system 140 is employed in this example to streamline the workflow and ensure the creation of a controllable, high-quality dataset.

This workflow begins by uploading a JSON file containing the company's updated database schema to the query annotation system 140. As the database schema 136 is loaded, the query annotation system 140 transforms a complex JSON structure into an intuitive visual representation. Tables appear as clearly defined boxes with columns listed inside, while relationships between tables are displayed as animated dashed lines. The visual layout supports improved understanding of the overall structure of the database, saving hours of time that would have been spent mentally parsing the JSON file.

Edits may be made through interacting with the user interface. Table names, for instance, are edited by double-clicking, lines are dragged to establish reference relationships, and the meaning of an abbreviated column name is documented. The ability to zoom in and out further helps navigate the complex structure. This process demonstrates a significant improvement in efficiency compared to editing the schema through the original schema definition file directly.

Given the database, the data scientist is ready to annotate text-to-database data by creating database queries 210 and corresponding natural language queries 220. To do so, the query annotation system 140 begins by generating a random database query 210:
Select Employees.name From Employees

WHERE Employees.department_id=5 AND Employees.salary >50000

To confirm understanding, an analyze button is selected an in response the query annotation system 140 shows a step-by-step analysis:

FROM Employees→Which data source should be considered?
In employees

WHERE Employees.department_id=5→Which department are employees from?
Filter employees from department 5

AND Employees.salary >50000→What salary range is of interest?
Keep employees with salary exceeding $50,000

SELECT Employees.name→What information should be returned?
Return the names of employees
   As the data scientist hovers over each step, a corresponding step is rendered and the corresponding database query element are visually linked.

Query annotation system 140 then generates a suggested natural language query for this database query.
“Who are the employees in the marketing department with a salary higher than
   $50,000 and have been with the company for over 5 years?”
      However, the data scientist notices that this natural language question does not correctly reflect the database query 210 and decides to use the alignment feature to refine it. Accordingly, the data scientist selects the check alignment button, to determine how well the generated question matches the database query 210. As a result, the data scient notices a phrase in the question and associated visual indication of a mismatch of “marketing department,” suggesting there is no corresponding element in the database query 210. Data scientist thus is informed that this information is irrelevant and is therefore removed.

To better understand the quality this suggested natural language query 220, the data scientist “hovers” a cursor over on the step-by-step explanation. In response, the query annotation system 140 provides visual links showing how steps in the step-by-step explanation 222 corresponds to elements of the natural language query 220. In this example, an explanation step “Filter employees from department 5” is visually indicated. This visual cue informs the data scientist that this step is not reflected in the current natural language query 220. Accordingly, the data scientist is prompted by the query annotation system 140 to address these issues one by one.

First, data scientist removes the irrelevant information by deleting the phrase “marketing” and the unrelated condition “and have been with the company for over 5 years” from the natural language query 220. Next, the data scientist addresses the missing information about the department by “hovering” a cursor over a visually indicated step in the step-by-step explanation 222 of “Department 5,” and an inject button is rendered in the user interface. Responsive to selecting this option, the current natural language query 220 is updated by incorporating this step. With these adjustments made, the natural language query 220 now reads:
Who are the employees in Department 5
   with a salary higher than $50,000?

In order to view an effect of the edits, the data scientist again selects the “check alignment” button. In response, the user interface indicates that each step in the step-by-step explanation 222 successfully corresponds to a elements in the natural language query 220. As a final check, the data scientist hovers over different parts of the database query 210 to confirm that step successfully corresponds to an element in the database query 210.

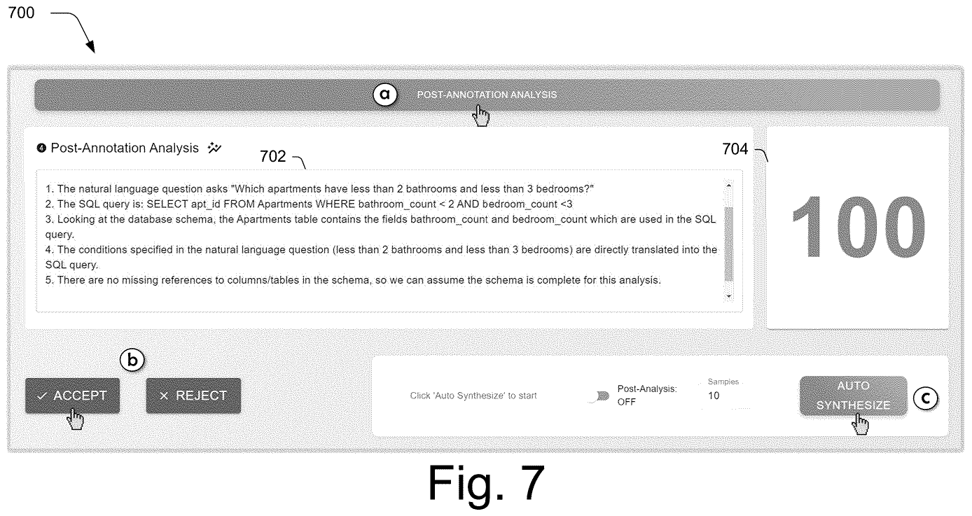

FIG. 7 depicts a user interface 700 in an example implementation as generated by the query annotation system 140 in support of post-synthesis analysis and automated annotation. In the illustrated user interface 700, the query annotation system 140 reports the equivalence analysis in a paragraph 702 along with a confidence score of “100.” The query annotation system 140 is further configurable to periodically analyze the dataset composition to ensure creation of a diverse and balanced dataset.

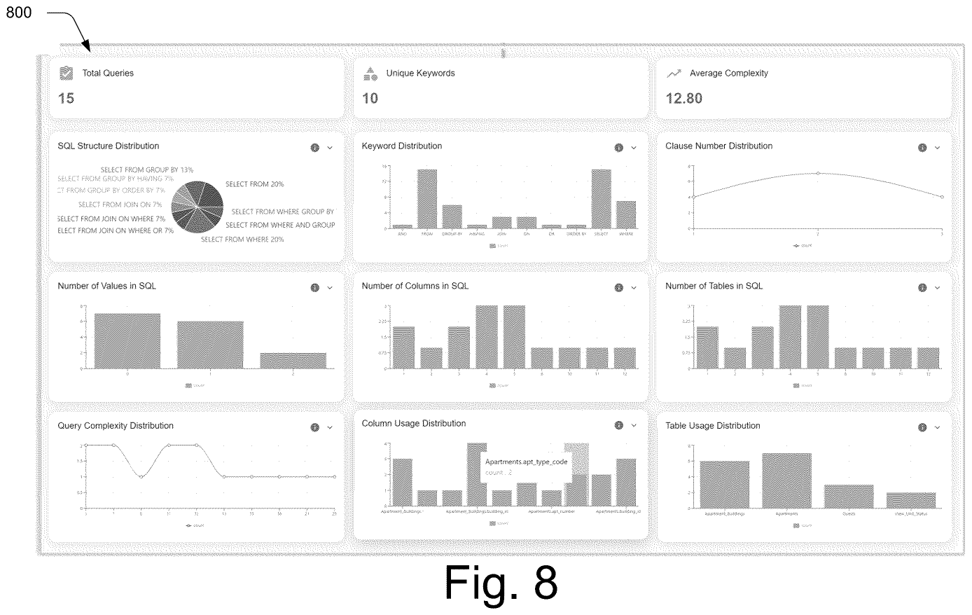

FIG. 8 depicts a user interface 800 in an example implementation as generated by the query annotation system 140 in support of dataset diversity analysis. To ensure diversity and eliminate potential biases in the annotated dataset, the query annotation system 140 is configurable to monitor dataset composition and property distributions. Users, for instance, can upload a dataset via drag and-drop and in response the query annotation system 140 renders various property distributions in pie charts, bar charts, or line charts, in terms of database query structure, keyword, clause number, column usage, etc. For example, the user interface 700 is configurable to monitor a number of referenced values in a bar chart.

If it is found that a database query 210 with a sufficient number of referenced values is underrepresented in a current dataset, the query annotation system 140 adjusts probabilities of the PCFG techniques to generate database query 210 having additional representations. Further, the query annotation system 140 is configurable to selectively accept those queries that contain an adequate number of values. In addition to ensuring diversity, this user interface 800 generally improves human control during collaboration with the LLM 144, enabling improved management of annotation pace and focus.

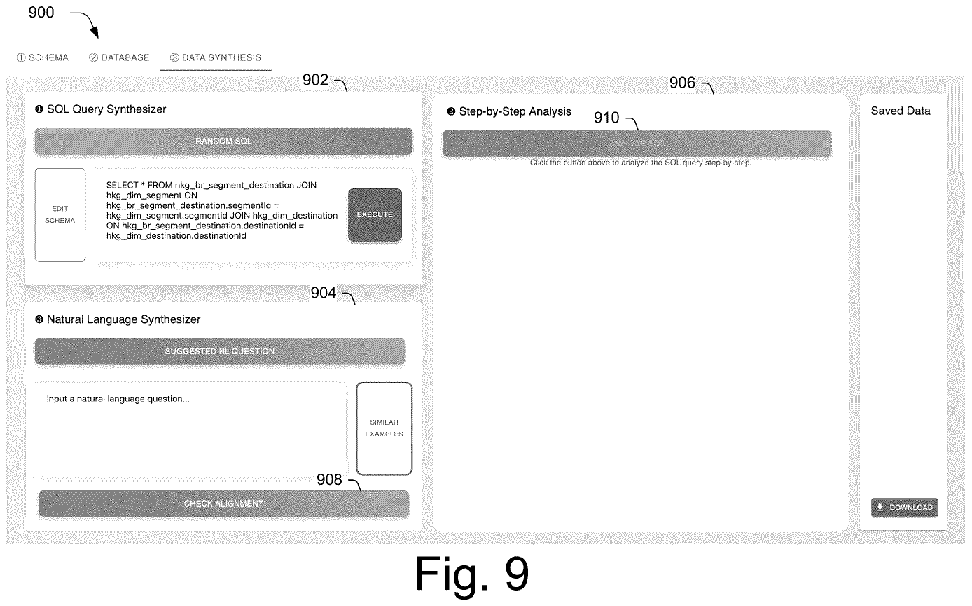

FIG. 9 depicts a user interface 900 in an example implementation as generated by the query annotation system 140 in support of database query synthesis. The user interface 900 includes a plurality of portions that include a database query generation portion 902, a natural language synthesis portion 904, and a step-by-step analysis portion 906. The user interface also includes a check alignment button 908. The check alignment button 908 is configured to allow users to verify the alignment of elements and steps between natural language queries, corresponding database queries, and the step-by-step analysis. In this example, a user input is received as selecting an “analyze SQL” button 910 that is configured to generate the step-by-step explanation, a result of which is described in the following discussion.

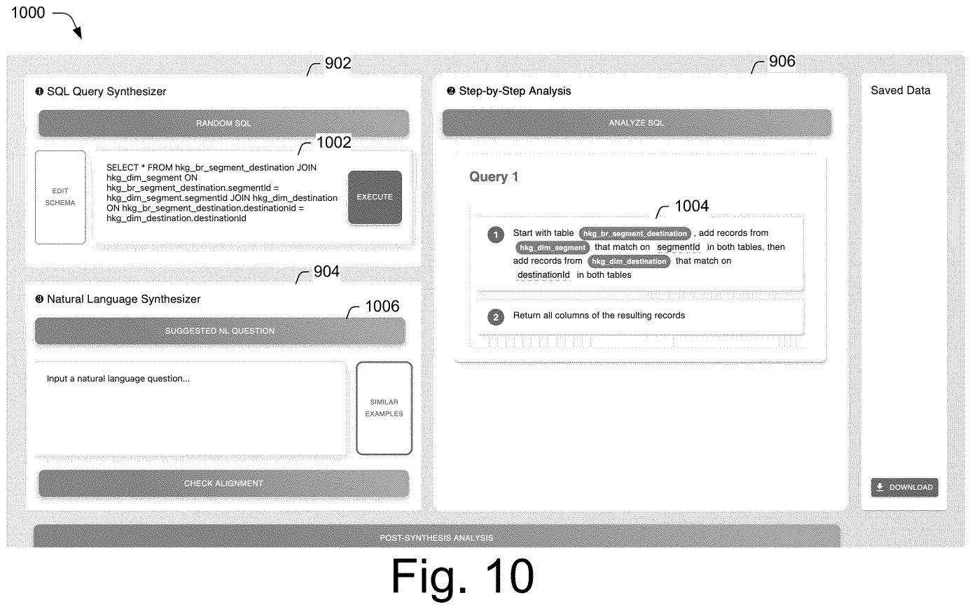

FIG. 10 depicts a user interface 1000 in an example implementation as generated by the query annotation system 140 in support of database query decomposition. The query annotation system 140 employs the query analysis module 212 to process and analyze database queries, corresponding natural language translations, and steps of a step-by-step analysis. The database query generation portion 902 includes an example of database queries 210 generated based on a database schema 136 and an example 1004 of a step-by-step explanation 222 indicating how the database query 210 is generated, elements of which support user selection to show correspondence between the elements and steps through visual indications. A “suggested NL question” option 1006 is selected to initiate generation of the natural language query 220, an example of which is further describing in the following discussion.

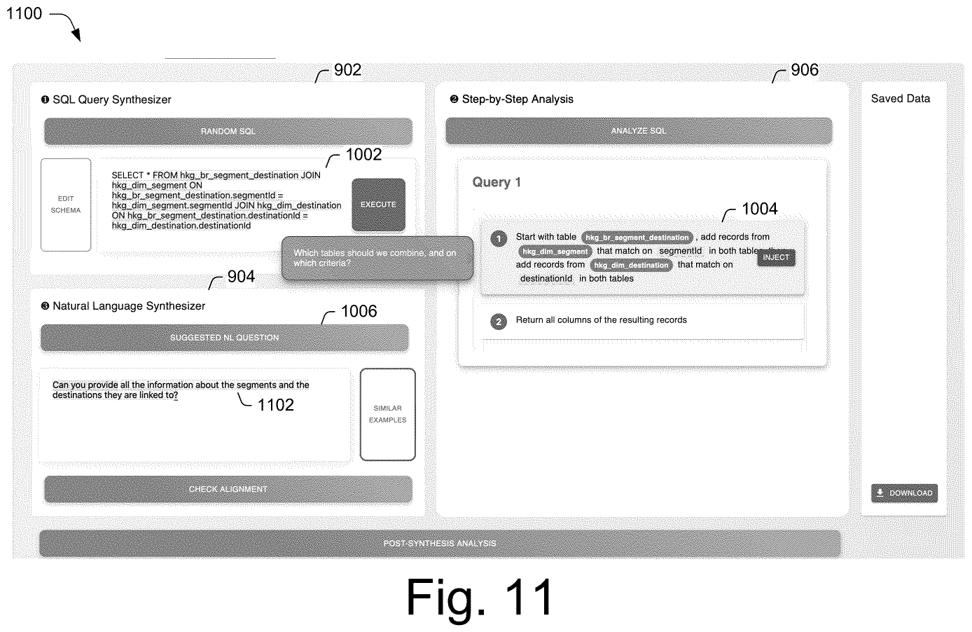

FIG. 11 depicts a user interface 1100 in an example implementation as generated by the query annotation system 140 in support of natural language query generation. In this example, an example 1102 of a natural language query 220 is output. The example 1102 of the natural language query 220 is visually linked with the example 1002 of the database query 210 and the example 1004 of the step-by-step explanation 222.

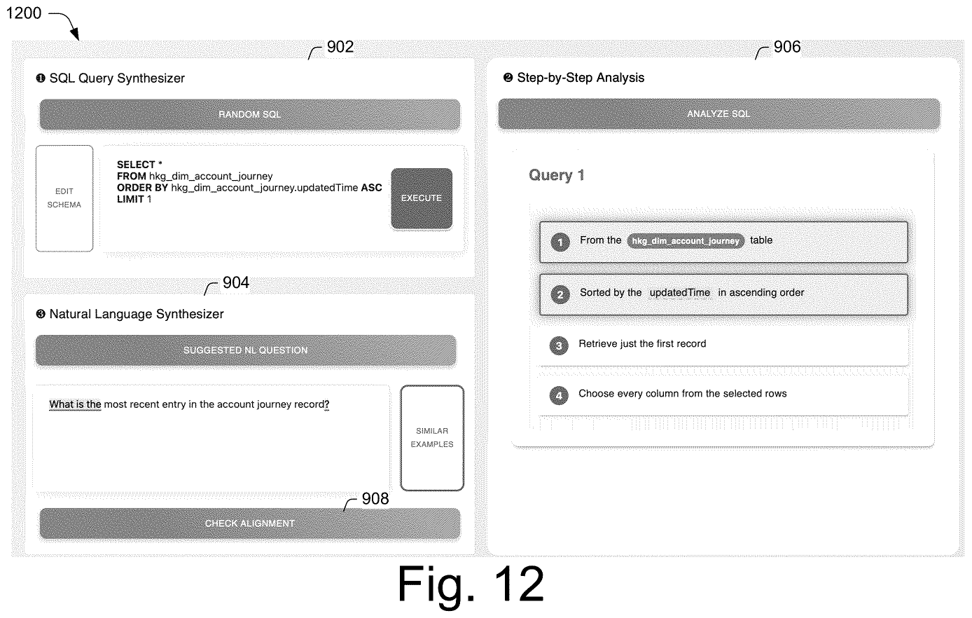

FIG. 12 depicts a user interface 1200 in an example implementation as generated by the query annotation system 140 in support of alignment generation techniques based on visual linking of query elements with steps of a step-by-step explanation. Alignment of elements of the queries (e.g., the database query 210 and/or the natural language query 220) with steps of the step-by-step explanation 222/is usable to identify potential mismatches and errors. Visual indicators (e.g., color coding) are used in the example by the query annotation system 140 to identify potential mismatches in the user interface 1200.

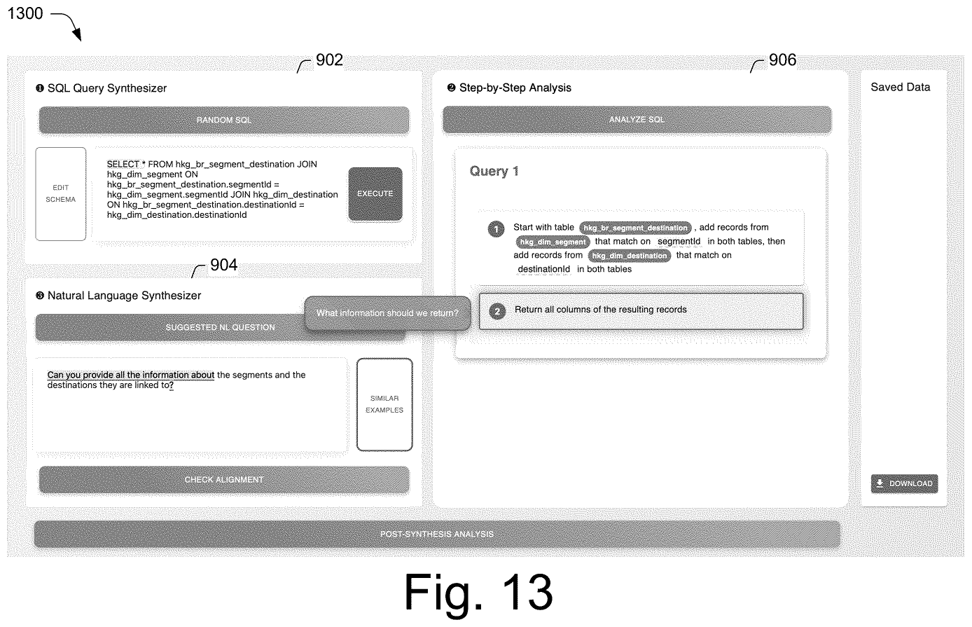

FIG. 13 depicts a user interface 1300 in an example implementation as generated by the query annotation system 140 in support of alignment checking techniques based on visual linking of query elements with steps of a step-by-step explanation. As previously described, alignment of elements of the queries (e.g., the database query 210 and/or the natural language query 220) with steps of the step-by-step explanation 222 is usable to identify potential mismatches and errors. Visual indicators (e.g., color coding) is used in the example by the query annotation system 140 to identify potential mismatches in the user interface 1200. In this example a selection of elements of the natural language query 220 of “can you provide all the information about” is analyzed in the step-by-step analysis portion 906 of the step-by-step explanation 222 as “return all columns of the resulting records.”

Returning again to FIG. 2, The query annotation system 140 is configured to continue the process of generating the database query 210 and natural language query 220 as training data 142 until a sufficient quantity of training data is obtained that is suitable for training a machine-learning model 134 to perform translation to convert the natural language query 116 into the database query 130. Once obtained, the machine-learning model 134 is trained based on the natural language query 220 and the database query 210 to translate the natural language query into the database query (block 1414).

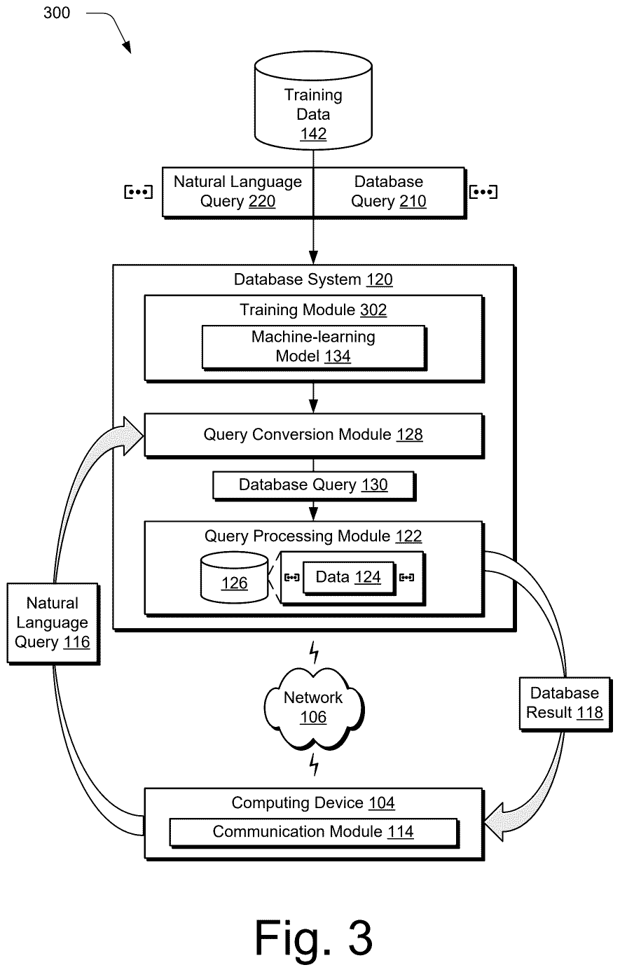

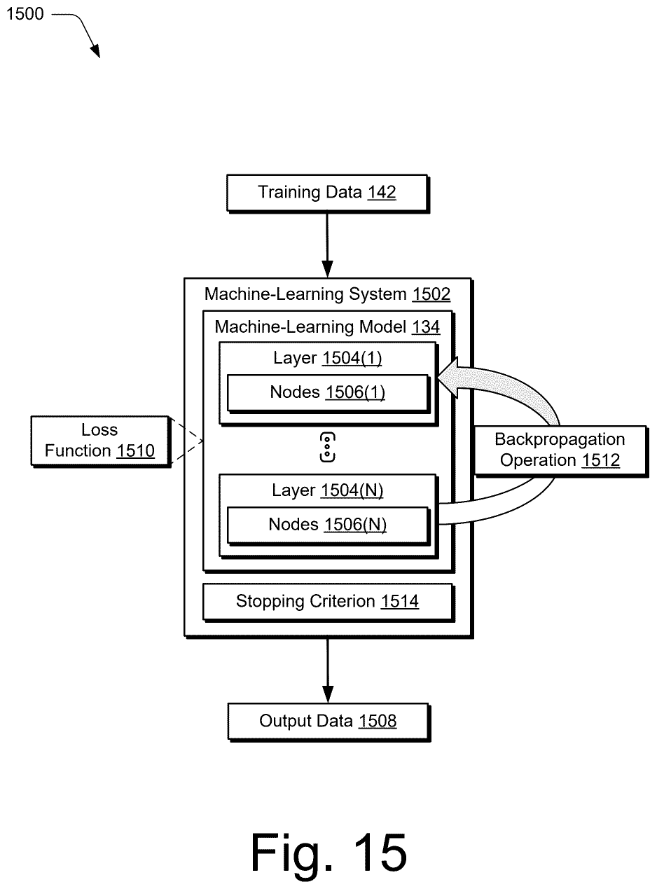

FIG. 3 depicts a system 300 showing operation of the database system 120 in greater detail as training the machine-learning model 134 based on the training data 142. A training module 302, for instance, obtains the natural language query 220 and the database query 210 as positive training samples. Negative training samples may also be generating, e.g., randomly, through modification of the positive training samples, and so forth. Further discussion of training of the machine-learning model 134 is described in relation to FIG. 15.

Once trained, the query conversion module 128 employs the machine-learning model 134 to process the natural language query 116 to form a database query 130 that is compatible with the database manager module 122 to generate the result 118.

FIG. 15 depicts a system in an example implementation showing training of the machine-learning model 134 of FIG. 1 in greater detail using the training data 142 as generated in FIG. 2. The machine-learning model 134 is illustrated as implemented as part of a machine-learning system 1502. The machine-learning system 1502 is representative of functionality to generate training data 142, use the generated training data 142 to train the machine-learning model 134, and/or use the trained machine-learning model 134 as implementing the functionality described herein.

A machine-learning model 134 refers to a computer representation that is tunable (e.g., through training and retraining) based on inputs without being actively programmed by a user to approximate unknown functions, automatically and without user intervention. In particular, the term machine-learning model includes a model that utilizes algorithms to learn from, and make predictions on, known data by analyzing training data to learn and relearn to generate outputs that reflect patterns and attributes of the training data. Examples of machine-learning models include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

In the illustrated example, the machine-learning model 134 is configured using a plurality of layers 1504(1), . . . , 1504(N) having, respectively, a plurality of nodes 1506(1), . . . , 1506(N). The plurality of layers 1504(1)-1504(N) are configurable to include an input layer, an output layer, and one or more hidden layers. Calculations are performed by the nodes 1506(1)-1506(N) within the layers via hidden states through a system of weighted connections that are “learned” during training of the machine-learning model 134 to implement a variety of tasks.

In order to train the machine-learning model 134, training data 142 is received that provides examples of “what is to be learned” by the machine-learning model 134, i.e., as a basis to learn patterns from the data. The machine-learning system 1502, for instance, collects and preprocesses the training data 142 that includes input features and corresponding target labels, i.e., of what is exhibited by the input features), such as the natural language query and the database query.

The machine-learning system 1502 then initializes parameters of the machine-learning model 134, which are used by the machine-learning model 134 as internal variables to represent and process information during training and represent interferences gained through training. In an implementation, the training data 142 is separated into batches to improve processing and optimization efficiency of the parameters of the machine-learning model 134 during training.

The training data 142 is then received as an input by the machine-learning model 134 and used as a basis for generating predictions based on a current state of parameters of layers 1504(1)-1504(N) and corresponding nodes 1506(1)-1506(N) of the model, a result of which is output as output data 1508. Output data 1508 describes an outcome of the task, e.g., as a probability of being a member of a particular class in a classification scenario.

Training of the machine-learning model 134 includes calculating a loss function 1510 to quantify a loss associated with operations performed by nodes of the machine-learning model 134. The calculating of the loss function 1510, for instance, includes comparing a difference between predictions specified in the output data 1508 with target labels specified by the training data 142. The loss function 1510 is configurable in a variety of ways, examples of which include regret, Quadratic loss function as part of a least squares technique, and so forth.

Calculation of the loss function 1510 also includes use a backpropagation operation 1512 as part of minimizing the loss function 1510 and thereby training parameters of the machine-learning model 134. Minimizing the loss function 1510, for instance, includes adjusting weights of the nodes 1506(1)-1506(N) in order to minimize the loss and thereby optimize performance of the machine-learning model 134 in performance of a particular task, e.g., query translation. The adjustment is determined by computing a gradient of the loss function 1510, which indicates a direction to be used in order to adjust the parameters to minimize the loss. The parameters of the machine-learning model 134 are then updated based on the computed gradient.

This process continues over a plurality of iteration in an example until a stopping criterion 1514 is met. The stopping criterion 1514 is employed by the machine-learning system 1502 in this example to reduce overfitting of the machine-learning model 134, reduce computational resource consumption, and promote an ability of the machine-learning model 134 to address previously unseen data, i.e., that is not included specifically as an example in the training data 142. Examples of a stopping criterion 1514 include but are not limited to a predefined number of epochs, validation loss stabilization, achievement of a performance improvement threshold, or based on performance metrics such as precision and recall.

Configuration of the training data 142 is usable to support a variety of usage scenarios. In one example, the training data 142 is configured to train the machine-learning model 134 to translate a natural language query into a database query. A variety of other examples are also contemplated.

### Example System and Device

FIG. 16 illustrates an example system generally at 1600 that includes an example computing device 1602 that is representative of one or more computing systems and/or devices that implement the various techniques described herein. This is illustrated through inclusion of the query annotation system 140 having the training data 142 and LLM 144. The computing device 1602 is configurable, for example, as a server of a service provider, a device associated with a client (e.g., a client device), an on-chip system, and/or any other suitable computing device or computing system.

The example computing device 1602 as illustrated includes a processing device 1604, one or more computer-readable media 1606, and one or more I/O interface 1608 that are communicatively coupled, one to another. Although not shown, the computing device 1602 further includes a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing device 1604 is representative of functionality to perform one or more operations using hardware. Accordingly, the processing device 1604 is illustrated as including hardware element 1610 that is configurable as processors, functional blocks, and so forth. This includes implementation in hardware as an application specific integrated circuit or other logic device formed using one or more semiconductors. The hardware elements 1610 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically-executable instructions.

The computer-readable storage media 1606 is illustrated as including memory/storage 1612 that stores instructions that are executable to cause the processing device 1604 to perform operations. The computer-readable storage medium is configured for storing instructions that, responsive to execution by the processing device, causes the processing device to perform operations. The memory/storage 1612 represents memory/storage capacity associated with one or more computer-readable media. The memory/storage 1612 includes volatile media (such as random access memory (RAM)) and/or nonvolatile media (such as read only memory (ROM), Flash memory, optical disks, magnetic disks, and so forth). The memory/storage 1612 includes fixed media (e.g., RAM, ROM, a fixed hard drive, and so on) as well as removable media (e.g., Flash memory, a removable hard drive, an optical disc, and so forth). The computer-readable media 1606 is configurable in a variety of other ways as further described below.

Input/output interface(s) 1608 are representative of functionality to allow a user to enter commands and information to computing device 1602, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1602 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing device 1602. By way of example, and not limitation, computer-readable media includes “computer-readable storage media” and “computer-readable signal media.”“Computer-readable storage media” refers to media and/or devices that enable persistent and/or non-transitory storage of information (e.g., instructions are stored thereon that are executable by a processing device) in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 1602, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1610 and computer-readable media 1606 are representative of modules, programmable device logic and/or fixed device logic implemented in a hardware form that are employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also be employed to implement various techniques described herein. Accordingly, software, hardware, or executable modules are implemented as one or more instructions and/or logic embodied on some form of computer-readable storage media and/or by one or more hardware elements 1610. The computing device 1602 is configured to implement particular instructions and/or functions corresponding to the software and/or hardware modules. Accordingly, implementation of a module that is executable by the computing device 1602 as software is achieved at least partially in hardware, e.g., through use of computer-readable storage media and/or hardware elements 1610 of the processing device 1604. The instructions and/or functions are executable/operable by one or more articles of manufacture (for example, one or more computing devices 1602 and/or processing devices 1604) to implement techniques, modules, and examples described herein.

The techniques described herein are supported by various configurations of the computing device 1602 and are not limited to the specific examples of the techniques described herein. This functionality is also implementable all or in part through use of a distributed system, such as over a “cloud” 1614 via a platform 1616 as described below.

The cloud 1614 includes and/or is representative of a platform 1616 for resources 1618. The platform 1616 abstracts underlying functionality of hardware (e.g., servers) and software resources of the cloud 1614. The resources 1618 include applications and/or data that can be utilized while computer processing is executed on servers that are remote from the computing device 1602. Resources 1618 can also include services provided over the Internet and/or through a subscriber network, such as a cellular or Wi-Fi network.

The platform 1616 abstracts resources and functions to connect the computing device 1602 with other computing devices. The platform 1616 also serves to abstract scaling of resources to provide a corresponding level of scale to encountered demand for the resources 1618 that are implemented via the platform 1616. Accordingly, in an interconnected device embodiment, implementation of functionality described herein is distributable throughout the system 1600. For example, the functionality is implementable in part on the computing device 1602 as well as via the platform 1616 that abstracts the functionality of the cloud 1614.

In implementations, the platform 1616 employs a “machine-learning model” that is configured to implement the techniques described herein. A machine-learning model refers to a computer representation that can be tuned (e.g., trained and retrained) based on inputs to approximate unknown functions. In particular, the term machine-learning model can include a model that utilizes algorithms to learn from, and make predictions on, known data by analyzing training data to learn and relearn to generate outputs that reflect patterns and attributes of the training data. Examples of machine-learning models include neural networks, convolutional neural networks (CNNs), long short-term memory (LSTM) neural networks, decision trees, and so forth.

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

1. A method comprising:
forming, by a processing device, a source database and a database query for the source database based on a database schema;
generating, by the processing device, a natural language query based on the database query using one or more machine-learning models;
annotating, by the processing device, a step-by-step explanation of how the natural language query is generated from the database query using one or more machine learning models;
displaying, by the processing device, the step-by-step explanation using a user interface;
receiving, by the processing device, an edit to the natural language query via the user interface;
forming, by the processing device, an edited natural language query based, at least in part, on the natural language query and the edit to the natural language query; and
training, by the processing device, a machine-learning model based on the edited natural language query and the database query to translate the natural language query into the database query.

2. The method as described in claim 1, wherein the database query is a structured query language (SQL) query.

3. The method as described in claim 1, wherein the forming includes populating a plurality of records into the source database, automatically and without user intervention.

4. The method as described in claim 3, further comprising receiving an input via the user interface specifying a number of the plurality of records to be populated into the source database and wherein the populating includes populating the number of the plurality of records, automatically and without user intervention, into the source database.

5. The method as described in claim 1, wherein the forming of the database query includes sampling grammar of the source database or the database schema using probabilistic context-free grammar (PCFG).

6. The method as described in claim 5, wherein the probabilistic context-free grammar (PCFG) is configured based on a learned keyword probability distribution based on the source database or the database schema.

7. The method as described in claim 1, wherein the generating of the database query is performed using the one or more machine-learning models based on the database schema.

8. The method as described in claim 1, wherein the user interface is configured to display text of the natural language query and the edit is made to the text.

9. The method as described in claim 1, wherein the user interface is configured to display the natural language query concurrently with the database query.

10. The method as described in claim 1, wherein the user interface includes a step-by-step explanation generated by the one or more machine-learning models of how the natural language query is generated from the database query.

11. The method as described in claim 10, wherein steps of the step-by-step explanation are visually linked with respective elements of the natural language query in the user interface.

12. The method as described in claim 11, wherein steps of the step-by-step explanation are visually linked with respective elements of the database query in the user interface.

13. The method as described in claim 1, wherein the forming of the edited natural language query includes presenting the natural language query as generated using the one or more machine-learning models for display in the user interface and receiving the edit to text of the natural language query via the user interface.

14. The method as described in claim 1, further comprising:
presenting the database schema for display in the user interface; and
editing the database schema responsive to one or more edits received via the user interface and wherein the forming of the database query is performed based on the database schema having the one or more edits.

15. A computing device comprising:
a processing device; and
a computer-readable storage medium storing instructions that, responsive to execution by the processing device, causes the processing device to perform operations including:
generating, using the one or more machine-learning models, a natural language query and an annotation including a step-by-step explanation of how the natural language query is generated from a database query;
displaying the natural language query and the annotation using a user interface;
receiving by the user interface one or more edits to the natural language query; and
training a machine-learning model based on the one or more edits to the natural language query and the database query, the training configured to teach the machine-learning model to translate the natural language query into the database query.

16. The computing device as described in claim 15, wherein steps of the step-by-step explanation are visually linked with elements of the natural language query.

17. The computing device as described in claim 15, wherein steps of the step-by-step explanation are visually linked with elements of the database query.

18. The computing device as described in claim 15, further comprising indicating a misalignment between the natural language query and the step-by-step explanation in a user interface.

19. (canceled)

20. (canceled)

21. One or more computer-readable storage media having instructions stored thereon that, responsive to execution by a processing device, causes the processing device to perform operations comprising:
forming a source database and a database query for the source database based on a database schema;
generating a natural language query based on the database query using one or more machine-learning models;
annotating a step-by-step explanation of how the natural language query is generated from the database query using one or more machine learning models;
displaying the step-by-step explanation using a user interface;
receiving an edit to the natural language query via the user interface;
forming an edited natural language query based, at least in part, on the natural language query and the edit to the natural language query; and
training a machine-learning model based on the edited natural language query and the database query to translate the natural language query into the database query.

22. The one or more computer-readable storage media as described in claim 21, wherein steps of the step-by-step explanation are visually linked with elements of the database query.
